(19) United States
(12) Patent Application Publication
(10) Pub. No.: US 2013/0312115 A1
(43) Pub. Date: Nov. 21, 2013

(54) HUMAN-AUTHORIZED TRUST SERVICE

(71) Applicant: Swan Island Networks, Inc., Portland, OR (US)

(72) Inventors: Charles Jennings, Portland, OR (US); David M. Jones, Portland, OR (US)

(73) Assignee: Swan Island Networks, Inc., Portland, OR (US)

(21) Appl. No.: 13/857,126

(22) Filed: Apr. 4, 2013

Related U.S. Application Data
(60) Provisional application No. 61/620,026, filed on Apr. 4, 2012.

(51) Int. Cl. G06F 21/62

(52) U.S. Cl. CPC G06F 21/62
USPC 726/28

(57) ABSTRACT

A method for authorizing access to data within a system is disclosed herein. The method includes authenticating a first trusted user identity corresponding to a first individual and granting that first trusted user identity a trust assertion privilege. The method then calls for transmitting an invitation to a second individual, the invitation including a trust assertion from said first user, and receiving and authenticating a second trusted user identity corresponding to said second individual. The trust assertion is dependent on a subjective decision by the first user to trust the second user. Next, a trust relationship between said first and second trusted user identities is recorded.

### CROSS-REFERENCE TO RELATED APPLICATIONS

This application claims the benefit of U.S. Provisional Application No. 61/620,026 entitled “COMMUNITY AUTHORIZED TRUST SYSTEM” filed on Apr. 4, 2012, the entire disclosure of which, is hereby fully incorporated herein by reference for all purposes.

### BACKGROUND

Recent Presidential Policy Directives (PPDs) on Cyber Security and Critical Infrastructure Protection are two of many calls for increased sharing of critical, often sensitive information, by government agencies and its private sector partners. These calls are not new. The United States' federal government has spent tens of millions of dollars over the past decade in support of various initiatives designed to increase public/private information sharing, but these efforts have either had very little success, or have failed altogether. The General Accounting Office (GAO), for one, has been highly critical of them.

The value of public/private information sharing, however, is seldom disputed. Practitioners in the field—experts in cyber security information standards, critical infrastructure operators, emergency responders, military personnel, technology vendors, et al.—generally view cross-organizational information sharing as a means of increasing early warning about a variety of threats (but principally cyber-attacks, terrorist attacks and severe weather.) Targeted, shared information extends the perimeter of threat and situational awareness, and thereby helps organizes defend against threats and mitigate their impact. The model is not unlike National Weather Service (NWS) forecasting, where more and better information synthesis before a hurricane's landfall produces more accurate predictions and improves early warning—thereby greatly reducing loss of life and property.

With nearly universal agreement about the need for new forms of cross-organization collaboration (notwithstanding concerns in some quarters about the privacy implications), why has progress been so slowly? The short answer: an inability to resolve information policy differences between government agencies, between private companies and, even more, among all as a group.

Information policy, in today's United States, is a complex labyrinth. It includes everything from sensitive information controls, to privacy statement assertions, to identity credentialing rules, to proprietary access authorization schemes. Laws, regulations, fiduciary responsibilities and securities disclosure regulations also play a part and no two companies, or government agencies, have the same policies.

Information policy for information sharing, of whatever kind, is also highly dependent on technical information controls, and technology information standards. Technologies supporting trusted information exchange are often proprietary, or (to use a favorite GAO phrase) “siloed.” There are also many competing data schemas. In the cyber security incident reporting area alone, public/private technical initiatives such as STIX/TAXII, OpenIOC, MILE and OASIS' CAP are competing to become the standard. The complexities of policy, technology interoperability and competing data standards have, over the past decade combined to make real progress in information sharing painfully slow.

To appreciate the significance of this situation, consider if the NWS used only human-to-human email to manage all of its data collection and dissemination. An entire layer of real-time sensor collection, data analytics and automated alert notification would disappear. Forecast accuracy would drop markedly; early warning services would diminish greatly; and lives would clearly be lost as a result every year.

A primary goal of those in the information sharing field, in both the public and private sectors, therefore, is to move from a reliance on emails (and, in some cases, primitive Web “portals'), to new technology platforms whose capabilities would improve cyber and critical infrastructure attack “early warnings” the way that similar massively connected NWS information services have with severe weather events.

NWS has built powerful, valuable information systems—but it has had a decided advantage over those attempting to build similar early warning systems for cyber security and critical infrastructure: for the most part, theirs was a technology challenge, not a policy challenge. Its vast network of sensors, data consumption services, analytical applications, communication networks, data stores and alerting systems all work under one set of information policies: those of the National Weather Service.

Bringing advanced data collection, analytics and intelligence into a heterogeneous policy environment, as is required for public/private information sharing, is a much thornier problem. The very fact that two new PPDs were required to emphasize the importance of developing national public/private information sharing services (after similar calls over ten years by the 9/11 Commission, the WMD Commission, PPD Homeland Security 21, et al.) is proof enough that information sharing is a hard problem, and one that has not yet been solved.

The United States has an urgent need for new public/private information services in support of better early warning about threats to our cyber and other critical infrastructures, but unless efforts to solve the information sharing problem utilize methods more closely aligned to this second project—those embodied in software and systems in this invention—this need will not be met any time soon.

Some conventional but insufficient attempts to address these and other problems with critical information sharing techniques are addressed below.

U.S. patent application Ser. No. 12/468,065 describes a claims-based authorization system that automates the process of authorizing a party for access to digital services based on claims associated with the party. A prior patent publication, US20090178123, also describes a method of automating the process for securing and accessing data; this method relates to Internet identities specifically and incorporates and relies on the use of public keys for data access. These patents generally describe Microsoft's claims-based authorization architecture.

Patent number U.S. Pat. No. 5,414,844 describes an automation process for controlling public access to a plurality of data objects using the identity of the user and an associated authorization level. It also speaks to a public user group entity and the process for automating authorization for a group of users under a common authorization profile. IBM's model, while providing a data access control methodology using explicit authorization mechanisms, does so using a centralized, rather than a highly distributed (i.e., user controlled) trust model. The patent is also very focused on individual records and storage devices.

Application US20080066159 speaks to a method for controlled delegation of rights within a system, in which those rights can be transferred from one delegate to another. This could be applied to a trust authorization system or security scheme relying on chained delegation.

In U.S. Pat. No. 7,991,902 patent an authorization model is described that is based on a value called “reputation value”, which is determined based on input from a group of human user's experience with a system. Based on that input, actions are taken by the system, which may further include prompts for additional human input, and may lead to performing or not performing the requested operations. In some cases, the authorization may take place as a combination of the reputation value and the type of operation and an associated security level. This is a good example of the insertion of human input in an authorization process. In this case the human input is a collective input, which goes to a system value. It is not in any direct way connected to service authorization or distributed information policy control. Furthermore, the human input that is collected is used to determine the reputation value of software rather than other humans.

### BRIEF DESCRIPTION OF THE DRAWINGS

Various embodiments in accordance with the present disclosure will be described with reference to the drawings, in which:

FIG. 1 is a high level schematic diagram depicting the internal organization of public and private organizations that may benefit from interacting with one another utilizing embodiments of the present methods and systems.

FIG. 2 is a schematic diagram depicting aspects of a non-limiting, exemplary computing architecture suitable for implementing at least some aspects and/or embodiments of the present systems and methods.

FIG. 3 is a flow chart depicting the formation of a human-trust based information sharing community in accordance with aspects of the present methods and systems.

FIG. 4 is a an organizational diagram showing the trust relationship among individuals within a human-trust based information sharing community in accordance with FIG. 3.

FIG. 5 is a diagram depicting aspects of the present methods and systems being advantageously utilized on top of a conventional information sharing system.

FIG. 6 is a flow chart depicting aspects of the creation of a trust assertion between two individuals in accordance with aspects of the present methods and systems.

### DETAILED DESCRIPTION

This description discusses various illustrative embodiments of the present methods and systems for a human-authorized trusted information exchange (“the present methods and systems”) with reference to the accompanying drawings in order to provide a person having ordinary skill in the relevant art with a full, clear, and concise description of the subject matter defined by the claims which follow, and to enable such a person to appreciate and understand how to make and use the same. However, this description should not be read to limit the scope of the claimed subject matter, nor does the presence of an embodiment in this description imply any preference of the described embodiment over any other embodiment, unless such a preference is explicitly identified herein. It is the claims, not this description or other sections of this document or the accompanying drawings, which define the scope of the subject matter to which the inventor and/or the inventor's assignee(s) claim exclusive rights.

Embodiments of the present methods and systems deliver a new kind of trustworthy credential, for example via an online service, that can be used to dynamically create information sharing capabilities and relationships, thereby permitting improved operational resilience for information technology systems, critical infrastructure and vital services. Certain aspects of the present methods and systems may advantageously include “human-chain-of-trust” credential management engine; an identity federation platform; a “Community of Trust” architecture; and a claims-based subscription service.

The present methods and systems solve many of the fundamental problems found in conventional public/private information sharing efforts wherein information sharing relationships are typically formed by and among large enterprises. Embodiments of the present methods and systems leverage the capabilities of known authentication/authorization infrastructures, such as the type used by large organizations in conventional information sharing systems, but further include transportable “Trust Assertion” credentials specific to individual people for information access authorization in a trusted credentialing service. This enables individuals (as opposed to just large enterprises) to use these trust-assertion bearing credentials to form a novel type of high-assurance information sharing communities

The present methods and systems are intended for use by emergency responders, cyber security engineers, law enforcement officers, critical infrastructure operators, corporate security staff, data center administrators, and other individuals, operating, defending and protecting critical infrastructure and services. Such critical infrastructure operators and defenders require a higher standard of information assurance, authentication/authorization and information control than the general public.

Embodiments of the present methods and systems therefore enable front-line operators to create their own information sharing communities, dynamically, to address critical problems (e.g., natural disasters, terrorist attacks, and other major emergencies). The present methods and systems advantageously provide such front-line operators, and others, with the kind of trust assertion capabilities conventionally deployed within large enterprises in an environment capable of delivering high information assurance and continuous, controlled, contextually appropriate access to both sensitive and non-sensitive information.

The present methods and systems advantageously permit trust credentialing and sensitive information access authorization services to be used by ordinary, individual people to enable sophisticated, highly secure information sharing. Embodiments of the present methods and systems provide a single trusted individual with the capability to create and manage human-chain-of-trust credentialing, so that she can create her own high assurance information sharing community—with the kind of information assurance today found only in the largest and best run enterprises. Embodiments of the present methods and systems may advantageously make the creation of such policies natural and intuitive at the ordinary user level (as opposed to something designed to be used by software engineers running large enterprise IT systems). Additionally, the “trusted credential” provider role is advantageously moved from the large enterprise, or the software application vendor, to the individuals on the front lines who need faster, better intelligence and early warning, and does so in ways consistent with their unique needs.

Certain embodiments of the present methods and systems may be viewed as a repository of authentication/authorization services and related trust credentials, accessible to trustworthy individuals as an online service. It is narrowly designed to address the very specific problems related to the initial launch and crucial early-stage development of information sharing communities in support of critical infrastructure and services.

Advantageously, embodiments of the present methods and systems may also plug-in existing enterprise authorization and identity management systems, when policies for doing so are place. The ability to connect with existing and future enterprise identity/credentialing systems is a necessary additional capability of the system, because information flows will undoubtedly increase as organizations begin to join the information sharing communities empowered by this invention, and begin to exchange their own sensitive incidents and intelligence.

The present methods and systems further the service for authorizing access to information sharing to be advantageously de-coupled from the various services provided to individual participants in an information sharing system.

Embodiments of the present methods and systems may be implemented by systems using one or more programmable digital computers. Computer and computer systems in connection with embodiments of the invention may act, e.g., as workstations and/or servers, such as described below. Digital voice and/or data networks such as may be used in connection with embodiments of the invention may also include components (e.g., routers, bridges, media gateways, etc.) with similar architectures, although they may be adapted, e.g., as known in the art, for their special purposes. Because of this commonality of architecture, such network components may be considered as computer systems and/or components of computer systems when consistent with the applicable context.

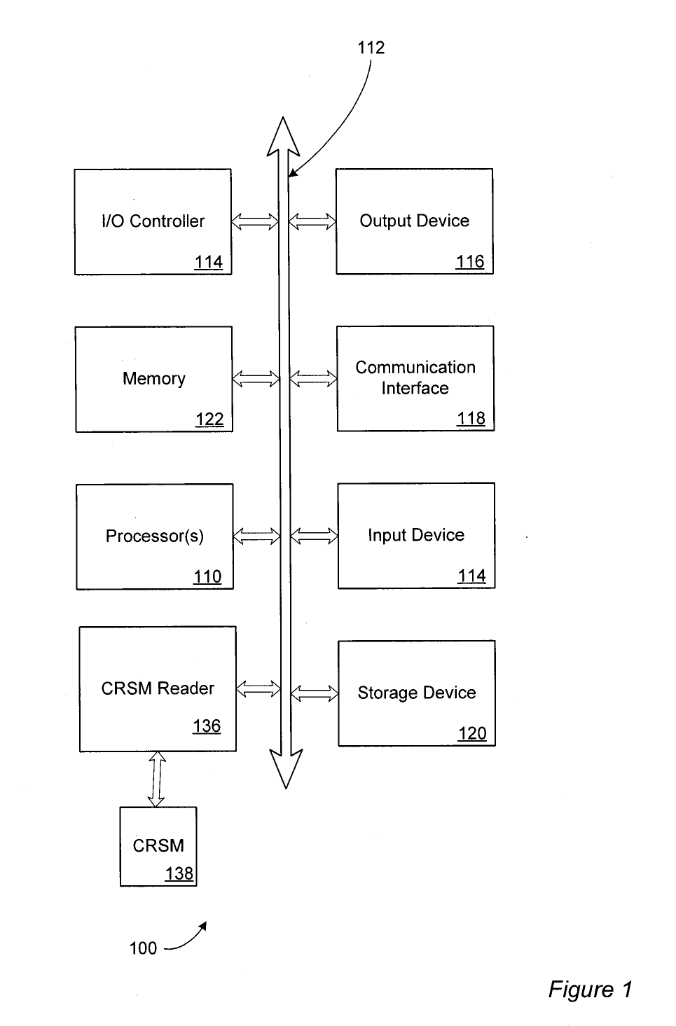

FIG. 1 depicts an example of one such computer system 100, which includes at least one processor 110, such as, e.g., an Intel or Advanced Micro Devices microprocessor, coupled to a communications channel or bus 112. The computer system 100 further includes at least one input device 114 such as, e.g., a keyboard, mouse, touch pad or screen, or other selection or pointing device, at least one output device 116 such as, e.g., an electronic display device, at least one communications interface 118, at least one data storage device 120 such as a magnetic disk or an optical disk, and memory 122 such as ROM and RAM, each coupled to the communications channel 112. The communications interface 118 may be coupled to a network (not depicted) such as the Internet.

Although the computer system 100 is shown in FIG. 1 to have only a single communications channel 112, a person skilled in the relevant arts will recognize that a computer system may have multiple channels (not depicted), including for example one or more busses, and that such channels may be interconnected, e.g., by one or more bridges. In such a configuration, components depicted in FIG. 1 as connected by a single channel 112 may interoperate, and may thereby be considered to be coupled to one another, despite being directly connected to different communications channels.

One skilled in the art will recognize that, although the data storage device 120 and memory 122 are depicted as different units, the data storage device 120 and memory 122 can be parts of the same unit or units, and that the functions of one can be shared in whole or in part by the other, e.g., as RAM disks, virtual memory, etc. It will also be appreciated that any particular computer may have multiple components of a given type, e.g., processors 110, input devices 114, communications interfaces 118, etc.

The data storage device 120 and/or memory 122 may store instructions executable by one or more processors or kinds of processors 110, data, or both. Some groups of instructions, possibly grouped with data, may make up one or more programs, which may include an operating system such as Microsoft Windows®, Linux®, Mac OS®, or Unix®. Other programs may be stored instead of or in addition to the operating system. It will be appreciated that a computer system may also be implemented on platforms and operating systems other than those mentioned. Any operating system or other program, or any part of either, may be written using one or more programming languages such as, e.g., Java®, C, C++, C#, Visual Basic®, VB.NET®, Perl, Ruby, Python, or other programming languages, possibly using object oriented design and/or coding techniques.

One skilled in the art will recognize that the computer system 100 may also include additional components and/or systems, such as network connections, additional memory, additional processors, network interfaces, input/output busses, for example. One skilled in the art will also recognize that the programs and data may be received by and stored in the system in alternative ways. For example, a computer-readable storage medium (CRSM) reader 136, such as, e.g., a magnetic disk drive, magneto-optical drive, optical disk drive, or flash drive, may be coupled to the communications channel 112 for reading from a CRSM 138 such as, e.g., a magnetic disk, a magneto-optical disk, an optical disk, or flash RAM. Alternatively, one or more CRSM readers may be coupled to the rest of the computer system 100, e.g., through a network interface (not depicted) or a communications interface 118. In any such configuration, however, the computer system 100 may receive programs and/or data via the CRSM reader 136. Further, it will be appreciated that the term “memory” herein is intended to include various types of suitable data storage media, whether permanent or temporary, including among other things the data storage device 120, the memory 122, and the CSRM 138.

The terms “computer-readable storage medium” and “computer-readable storage media” refer, respectively, to a medium and media capable of storing information. As such, both terms exclude transient propagating signals.

Two or more computer systems 100 may communicate, e.g., in one or more networks, via, e.g., their respective communications interfaces 118 and/or network interfaces (not depicted).

Embodiments of the present methods and systems may be implemented as a Human-Authorized Trust Service (HATS) to enable various individuals, who may be members of diverse organizations to form their own sensitive information sharing groups, person-to-person, among themselves, independently of the interoperability of their respective organizations information management systems.

Certain terms and phrases are given the following definitions when used herein.

Credential: “A credential is an attestation of qualification, competence, or authority issued to an individual by a third party with a relevant or de facto authority or assumed competence to do so.”

Trustworthy: This term should be evaluated in the context of Trustworthy computing which is, “ . . . applied to computing systems that are inherently secure, available, and reliable.”

Identity federation platform: Identity federations are systems of trustworthy computer systems that have, through an out-of-band process, arranged explicit trust relationships such that a relying party trusts an identity provider to assert the identity of clients accessing the system without requiring the relying party to identify them directly.

Claim: An assertion or fact made by an issuer about an agent/user. (See Federation)

Federation: “A federation is a collection of realms that have established a producer-consumer relationship whereby one realm can provide authorized access to a resource it manages based on an identity, and possibly associated attributes, that are asserted in another realm. Federation requires trust such that a Relying Party can make a well-informed access control decision based on the credibility of identity and attribute data that is vouched for by another realm.”

Disaggregating: Separate into parts. It's usage in our patent may be better served by using the synonym decoupling which is used more frequently in the software world.

Heterogeneous information sharing environment: Strictly speaking, the term simply identifies that most information technology systems are implemented differently using varying software and IT practices. With respect to the problem domain of this patent, systems which would benefit from an information sharing solution are distinct in policy, purpose, location and implementation.

Least privilege access principles: “ . . . the principle of least privilege . . . requires that in a particular abstraction layer of a computing environment, every module . . . must be able to access only the information and resources that are necessary for its legitimate purpose.” The User Account Control (UAC) mechanism in the Windows operating system is a prevalent example. In order to access higher privilege capabilities, the end-user must explicitly authorize the system as the software doesn't natively operate with high privileges.

Root of trust: A root of trust is an unconditionally trusted entity. In Public Key Infrastructure (see chain of trust) the role of the root of trust is served by the certificate of authority who issues the cryptographic certificates. In the Human Authorize Trust System, the root of trust is more localized and represents the first user to make a human trust assertion against another user. This new community of trust is only as trustworthy as that first individual.

Human Trust Assertion: An explicit declaration of trust by one user to another. These types of assertions may occur outside of any context and are unconditional.

Community Membership Assertion: An assertion that a user currently possesses a valid membership to a specific community. Conversely, this type of assertion could be a considered to be a Contextual Human Trust Assertion as the assertion is explicit and relates one user to another and is presented in the context of a HATS community.

Principal: An end-user that may act as an issuer of trust assertions.

Policy: A HATS policy is a collection of assertions that, if presented, would satisfy the trust requirements of the resources protected by the policy. For example, a policy protecting a repository of sensitive but unclassified data may state that a client must present a Community Membership Assertion for a specific Sworn Law Enforcement Officer community.

The present methods and systems may enable an individual to make a trust assertion about another individual, and then use this assertion to create and manage a cross-organizational information sharing group. In such a group, the individual who formed it, rather than his or her organization, becomes the group's “root of trust.”

When a government agency affirms the identity and trustworthiness of one of its badged employees, it is making a very solid trust assertion. This assertion is embedded in its various network systems and software applications, all (ideally) with significant data protection. However, when this same badged employee makes a similar assertion about his identity and trustworthiness on his own, outside of his agency and all its identity management and access control systems, the trust level is inherently lower.

To increase trust, confidence and assurance in an information service where the root of trust lies with one individual per community (rather than one organization), new technologies and methods are necessary to build trust, and maintain it.

HATS introduces these new technologies and methods based on a trust attestation model that maps humans trust as it is used in every day real life. A series of person-to-person connections and trust assertions form the foundation of trust, rather than the identity store of a large enterprise.

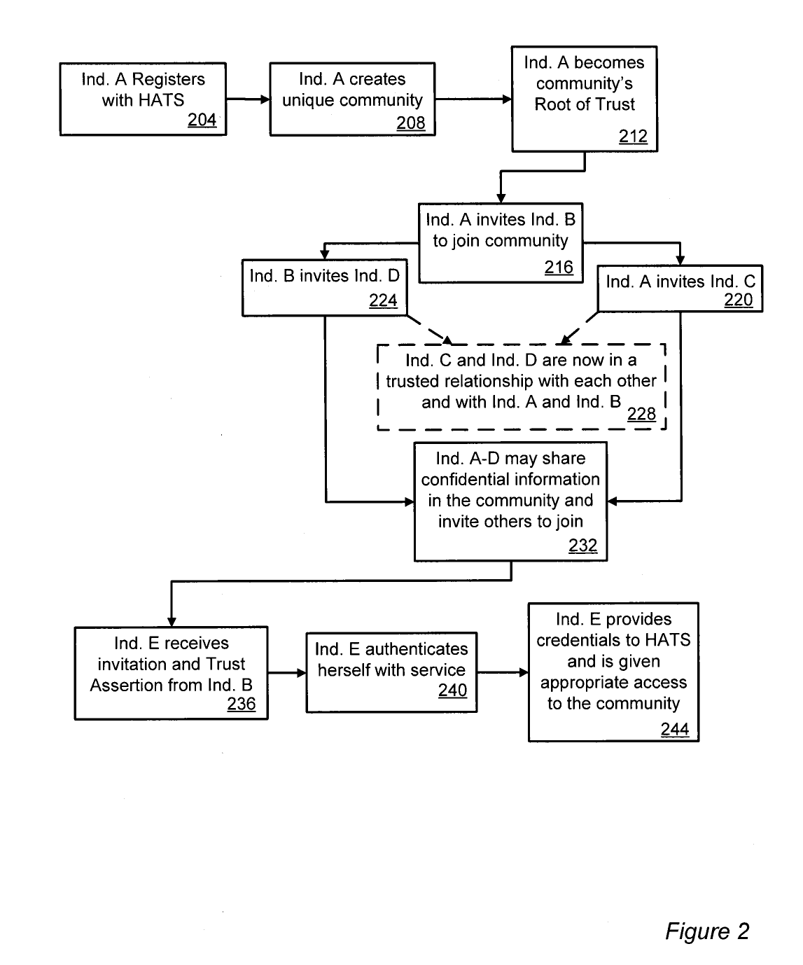

FIG. 2 depicts the formation of a HATS-based trust community in accordance with embodiments of the present invention. An individual A, who wishes to share information with other, trusted individuals, registers with HATS 204. Individual A then creates a unique information sharing community within the HATS repository 208, thus becoming the community's root of trust 212. When individual A encounters another individual, B, who individual A trusts and wishes to share information with, individual A may use HATS trusted credential sharing capabilities to invite individual B into individual A's information sharing community 216. Individual B becomes a fully trusted peer of Individual A. Individual A also fully trusts, and wishes to share information with, individual C, while individual B fully trusts, and wishes to share information with, individual D. Thus individual A invites individual C to join the community 220 and individual B invites individual D 224. Aspects of embodiments of the present methods and systems used to facilitate individuals C and D's entry into the community are described in more detail below, but here it is important to note that the key element in their gaining access to the community is a “Trust Assertion.” A Trust Assertion is a claim about trustworthiness embedded in a software credential that resides in the HATS environment. Through HATS, individuals C and D receive Trust Assertions from individuals A and B, respectively. Because of these Trust Assertions, all members of the community can feel reasonably confident about trusting each other 228, and confidential information may be exchanged within the community 232.

As a group of trusted peers, individuals A-D may collaborate using HATS to decide that each of these four peers can invite other individuals they know and trust into their information sharing community, but that the chain of trust should stop there. In other words, each peer can only invite others whom they can personally attest to be trustworthy.

Those others they invite into the community may be able to participate, but may not be able to extend any further invitations. In certain embodiments of the present methods and systems, this is known as a “one degree of separation” Trust Assertion policy.

In this above example, HATS enables only one simple “trust claim,” or access authorization policy: the one-degree-of-separation rule. But embodiments of the present methods and systems may also enable many access authorization policies, which may advantageously be configurable by a community's root of trust. Thus, an aspect of some embodiments of the present methods and systems may include a Trust Assertion user interface, for example accessible via a Web browser using a Web-enabled computing device. Non-limiting examples of such authorization policies, making use of configurable Trust Assertions, include:
Context-aware Authorization: Policies which provide access to some data, and not others, depending on the context, such as trusting an individual in the context of public safety, but not in the context of public health.
Time-limited Authorization: Policies which provide access to certain data, but only for a limited time. (“This credential is good for one month, during the emergency”);
Trusted But Anonymous (TBA) rules: Policies which govern the use of Personally Identifiable Information, or PII, in the service, especially with respect to exposure of PII to other members of a community; while at the same time conveying a level of trust within the community, based upon assurances regarding the credentials and trustworthiness of other participants. (“Everyone in this community is known to be trusted, and qualified in our field, but all information sharing will be done anonymously, without attribution”).
Affiliation Requirements: Policies which enforce authorization controls limiting participation in an information sharing community to users with a specific credential (“This community is open only to credentialed law enforcement officers, and school administrators in Chicago.”).

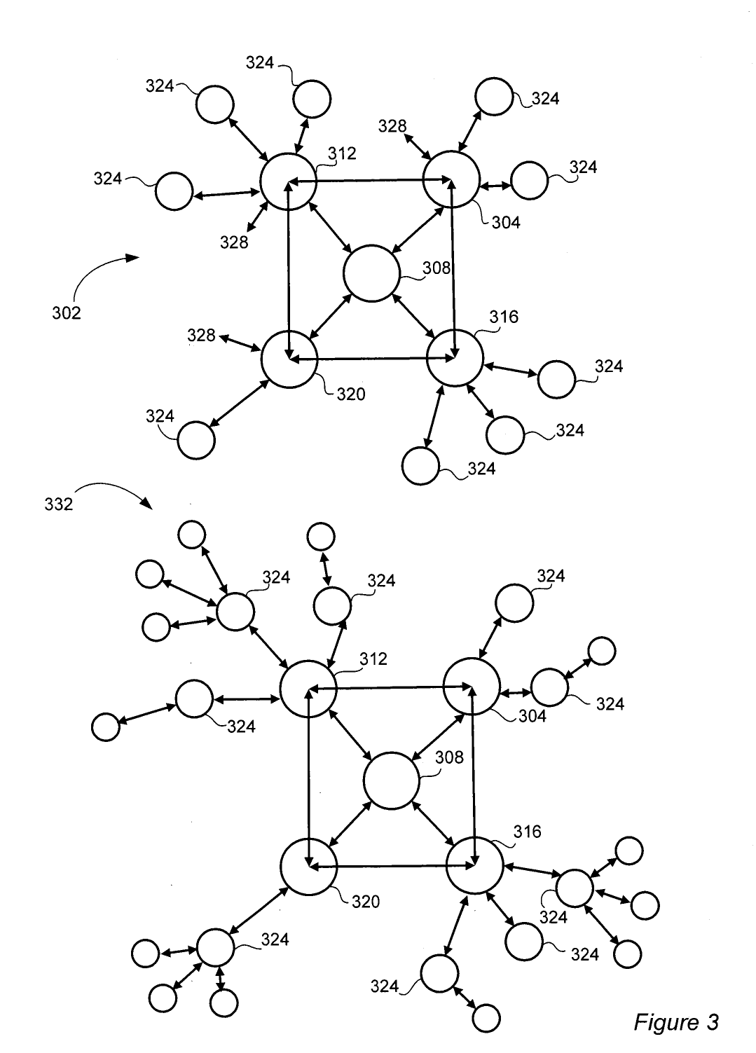

FIG. 3 depicts the community created by individual A based on a one-degree of separation policy 302, described above in reference to FIG. 2, individual A 304 creates the community 308 and invites user B 312 as a fully trusted peer. Individual A also invites individual C 316 and individual B 312 invites individual D 320, both as fully trusted peers. In a one degree of separation environment, fully trusted peers A-D can also invite other individuals they know to be trustworthy 324. These additional individuals are one-degree of separation 328 from the root of the community. Utilizing the Trust Assertion user interface, individual A. may selectively change the community's Trust Assertion policy from 1 degree of separation to 2 and thereby create a community 332 that looks considerably different.

In accordance with the goals of providing an effective tool for vital information sharing, embodiments of the present methods and systems may also deliver rigorous authentication, authorization and information security controls—delivered as a service in support of individual users. To achieve this, conventional trusted computing best practices, such as multi-factor authentication and claims-based authorization, may be leveraged to support a defined information sharing community. Multi-factor authentication makes it more difficult for non-trusted individuals to gain access to the service. Claims-based authorization decouples trusted credentialing from specific networks and applications in order to expand the reach and utility of credentials (embodied in software as a “claim”, or set of claims). A claim can be viewed as an assertion about an identity. This assertion can be based on a real-world credential, such as a passport or a physician's license; or, it can be an attestation by a third party (individual A claims individual B is trustworthy).

Referring again to FIG. 2, once individual A's information sharing community begins to provide access to sensitive information that has been submitted by its trusted participants, access management becomes critical. For a new community member E to get access to this information, she first must receive an invitation to join the community 236. This invitation must also include a Trust Assertion from an existing peer-level member of the community about her trustworthiness (at least in the context of Adam's specific information sharing community). After receiving a proper invitation and credentials, individual E next must authenticate herself to the service 240 (e.g. using conventional authentication techniques). When the service is satisfied that it really is individual E (or, more precisely E's trustworthy online persona) seeking to engage with the service, she automatically presents her HATS credentials to the service 244. These credentials contain one or more claims, or assertions, about her trustworthiness. Her credentials reside, as digitally signed objects, inside tokens managed by a HATS secure token server.

Individual E's credentials then interact with the information access policies of the community to authorize Eve to gain access to information being shared inside the community—either to all information accessible via the community, or some subset of it. Her validated trust claims serve as the key to unlock gates to the community's information.

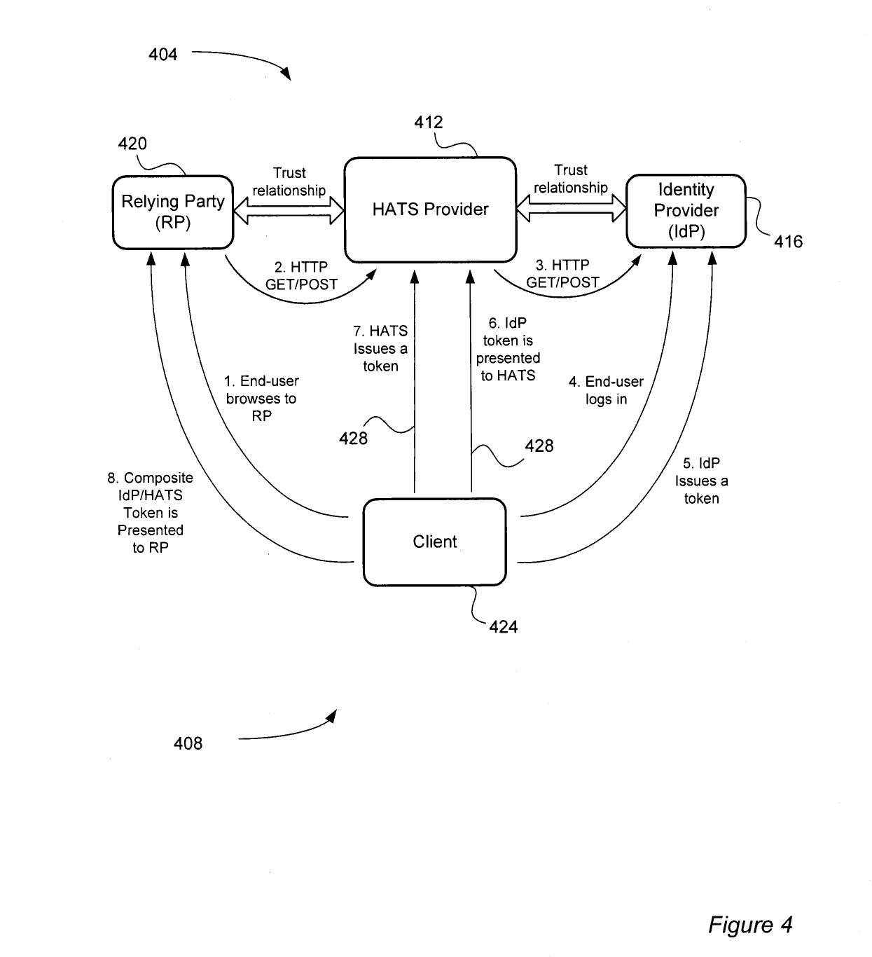

FIG. 4 depicts an exemplary workflow 404 that would may have been deployed to support individual E's attempt to join individual A's information sharing community. It is based upon use of a conventional WS Federation architecture 408 with the addition of a novel HATS credentialing service provider 412. By way of non-limiting example, such an embodiment of the present methods and systems provides the following, novel capabilities:

An ability to broker trust among an Identity Provider 416, a Relying Party 420 and an individual person (“Client”) 424; an ability for individual users 424 of the service to create and receive Trust Assertions that can be embedded in tokens 428, for example using a WS Federation model; and an ability to facilitate authorization transactions, dependent on Trust Assertions, that provide access to information via an information sharing community.

HATS also enables the creation of “Communities of Trust.” In this context, a Community of Trust is an aggregation of authenticated, authorized identities, authenticated to actual people, who have opted to share information with each other. The above diagram shows how a Community of Trust is created, in practice.

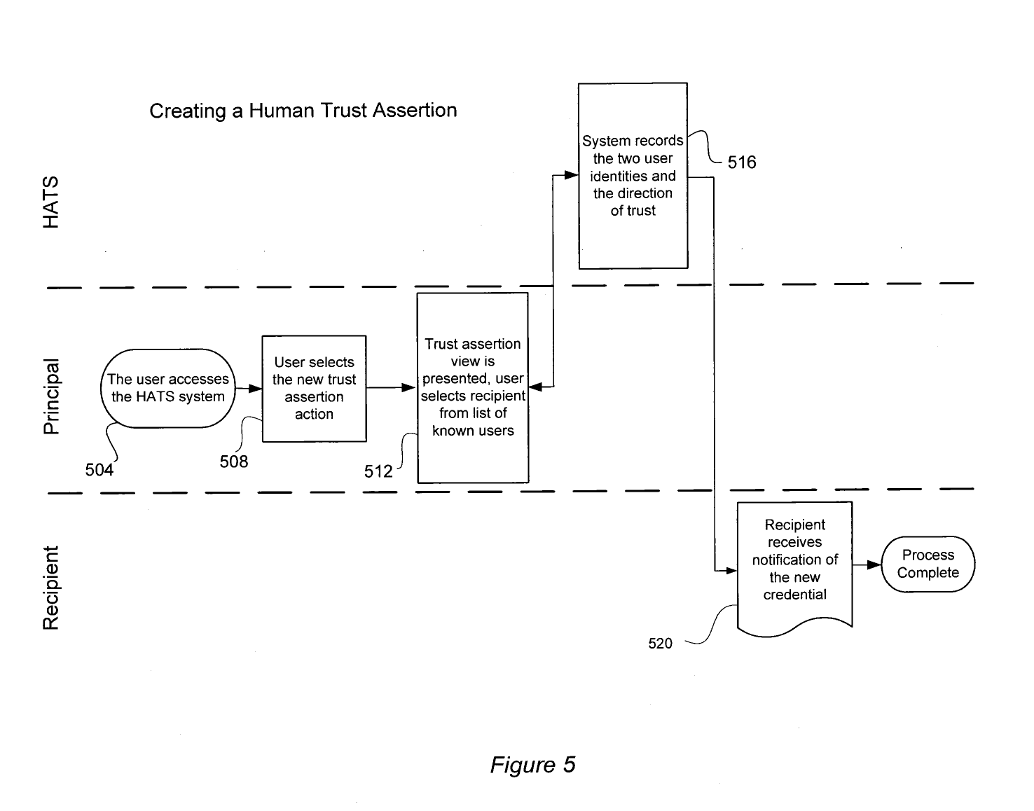

Referring to FIG. 5, another core capability of the present methods and systems is the ability to create a Trust Assertion that can be used with integrity throughout the service for various purposes. A user, such as individual A in the examples above, accesses the HATS system 504 and then selects a new trust assertion action 508. The system then presents the user with a list of other known users and the user may select whom to receive the new trust assertion 512. The system then records the identity of the two users as well as the direction of the trust assertion 516. The receiving user then receives a notification of the new credential 520. Using conventional industry standards, such as the WS-Trust specification, WS-Federation Claims, and SAML, HATS' credentials can advantageously also be used in large enterprise environments as well, once inter-organizational policies to do so are in place.

In accordance with embodiments of the present methods and systems, a HATS credential (and the various claims inside it), can be used to build or access information sharing communities based solely on individual trust assertions and related, individually configurable information polices (when the root of trust is one individual human). HATS credentials may also be configured to engage with traditional enterprise security credentialing systems (when the root of trust is a large organization).

At a surface level, his social trust credentialing service deployed in the present methods and systems resembles the social trust mechanisms used by such consumer services as Facebook and LinkedIn, but differs from them in several important ways. First in embodiment s of the present methods ad systems, trust is not just a simple link between two virtual identities; rather, it is a credential containing a set of attestations that can be used to grant fine-grain, enterprise-quality information access privileges. HATS credentials are further advantageously designed to be used in and across heterogeneous information sharing environments, not just a single commercial domain. HATS credentials are designed to be exchanged in the context of very high assurance computing environments, with security controls that a far more rigorous and stringent than those used in consumer services. Additionally, the authorization access enabled by the use of such a credential is much more controlled and particular than one used in a consumer service, and is deployed with adherence to least privilege access principles.

Further, a human-authorized trust service differs from previous public/private sensitive information sharing programs in that it begins by providing a service that enables individuals to use their roles, rank and trust positions to enable the creation of trusted information exchange environments individually, outside the formal information sharing policies of their organization. It does so in ways that do not violate current policies, but instead improves significantly (both in functionality and security) the methods and technology used by individuals to share information cross-organizationally today (mainly email). Finally, although organization policy approval is not required for the launch of information sharing using the human-chain-of-trust credentialing capability of the service, such organization policy can also be incorporated into the service, with an organization serving officially as the root of trust, rather than an individual.

Following are three non-limiting real-world examples of specific information sharing services that could be enabled by the present methods and systems:

A) A Safer Schools Initiative, enabling schools and local public safety stakeholders to share video surveillance feeds; school bus locations, via GPS tracking; filtered local 911 alerts; cell phone panic button notification; and trusted collaboration.

B) A Trusted-But-Anonymous Cyber Incident Reporting Service, enabling pro-active cyber monitoring across organizations.

C) A Physical+Logical Security Intelligence Service, targeted primarily to data center operators.

Example A) would likely require official policy approval by local schools and law enforcement agencies, but could support a variety of different capabilities from different vendors. Examples B) and C) would likely begin with individuals only—upgrading current informal information sharing practices—then migrate to active organizational involvement once the value and security of the service had been demonstrated.

Exemplary embodiments of the present methods and systems have been described in detail above and in the accompanying figures for illustrative purposes. However, the scope of the present methods and systems are defined by the claims below and is not limited to the embodiments described above or depicted in the figures. Embodiments differing from those described and shown herein, but still within the scope of the defined methods and systems are envisioned by the inventors and will be apparent to persons having ordinary skill in the relevant art in view of this specification as a whole. The inventors intend for the defined methods and systems to be practiced other than as explicitly described herein. Accordingly, the defined methods and systems encompass all modifications and equivalents of the subject matter as permitted by applicable law.

That which is claimed is:

1. A method for authorizing access to data within a system comprising the steps of:
(a) establishing a first trusted user identity corresponding to a first individual, thereby creating a trusted information sharing community;
(b) granting said first trusted user identity a trust assertion privilege;
(c) transmitting an invitation to a second individual, said invitation including a trust assertion from said first user;
(d) receiving and authenticating a second trusted user identity corresponding to said second individual;
(e) granting said second trusted user identity access to information available in said information sharing community; and
recording a trust relationship between said first and second trusted user identities in the system, and
wherein and is independent of any common organizational affiliation between said first and second users and the system is capable of providing trusted user identities access to said information sharing community without dependency on any one organizational affiliation, network domain or other outside element.

2. The method of claim 1, wherein said trust assertion is configurable to be dependent on the context of information being shared by said community.

3. The method of claim 1, wherein said trust assertion is temporally limited.

4. The method of claim 1, wherein said community has a plurality of member identities, including first and second trusted user identities, and wherein information is shared among members without attribution to a source of said information.

5. The method of claim 1, wherein said trust assertion is based on an individual being affiliated with a known organization.

6. The method of claim 1 wherein trust assertions may be transferred among members of said community.
